(19) United States
(12) Patent Application Publication
(10) Pub. No.: US 2009/0169590 A1
(43) Pub. Date: Jul. 2, 2009

(54) SYSTEM FOR REDUCING THE NUMBER OF PREDATOR FISH

(76) Inventor: Bradford L. Scott, Sagle, ID (US)

Correspondence Address: JENSEN + PUNTIGAM, P.S., 2033 6th Ave, Suite 1020, SEATTLE, WA, 98121, US

(21) Appl. No.: 11/964,629

(22) Filed: Dec. 26, 2007

(51) Int. Cl. A01N 25/34

(52) U.S. Cl. 424/408

(57) ABSTRACT

The system includes a capsule member made from a material which is dissolvable in the digestive fluids of a predator fish and at a selected rate in water. The capsule contains a material which, following ingestion by a predator fish, results in death of the predator fish. A connecting element secures the capsule to a prey fish at a selected location on the fish, including the mouth of the fish, and then released into an aqueous environment for ingestion by a predator fish.

### TECHNICAL FIELD

This invention relates generally to the reduction of predator fish in selected aqueous environments such as lakes, streams and the like, and more particularly concerns a system using a bait fish to accomplish such a reduction of predator fish.

### BACKGROUND OF THE INVENTION

In aqueous environments, such as lakes, that normally have a balance of predator and prey fish (also referred to as bait fish) populations, the prey fish are abundant enough to adequately support the predator fish population. The predator fish, which generally are desirable game or sport fish, are in turn usually caught in sufficient numbers by fishermen to maintain control over the number of their population.

Under various circumstances, however, an imbalance may occur in which the game fish significantly outnumber the prey fish, which are then consumed at a rate such as to threaten the continued existence of the prey fish, which in turn threatens the future existence of the game fish. In addition, other various factors can independently affect the population of the prey fish, including changes in the water level, which may expose the prey fish spawning beds, and high water flow periods, which may wash prey fish downstream. Other weather and environmental factors can also have a detrimental effect on the number of prey fish.

In such circumstances, it is important to quickly reduce the number of predator fish. Historically, one method is to poison the entire body of water, and then restock with the appropriate numbers of predator and prey fish populations. U.S. Pat. No. 4,395,969 to Cheng and U.S. Pat. No. 4,221,782 to MacPhee are examples of such a method. In addition, in some cases, fishing regulations are temporarily modified in order to increase the number of predator/game fish caught by fishermen, thereby reducing the threat to the prey fish. However, this particular method has not proven to be a reliable or significant solution to the problem.

With respect to a solution, it is desirable to be able to reliably control/reduce the numbers of predator fish in a given body of water without having to completely poison the body of water.

Other systems for reliably controlling and reducing the numbers of predator fish are shown in U.S. Pat. Nos. 6,886,290 and 7,114,286, both of which are owned by the owner of the present invention. Improvements to the systems disclosed in those two patents are disclosed herein.

### SUMMARY OF THE INVENTION

Accordingly, disclosed herein is a system for controlling the number of a selected population of fish in a given aqueous environment, comprising: a capsule member which includes material which, following ingestion by a fish in a selected population, results in death of said selected population fish, wherein the capsule is made from a material which dissolves in the digestive fluids of said fish and also dissolves in the aqueous environment at a selected rate, wherein the capsule is secured to a prey fish which is released into the aqueous environment for ingestion by said selected population fish; and a connecting element for securing the capsule to the prey fish.

Also disclosed herein is a system for controlling the number of a selected population fish in a given aqueous environment, comprising: a capsule member which includes material which, following ingestion by a fish in a selected population results in death of said population fish, wherein the capsule is made from material which dissolves in the digestive fluids of said fish, wherein the capsule is secured to the mouth of a prey fish in such a manner that the capsule is carried inside the mouth of the fish, the prey fish being released into the aqueous for ingestion by said selected population fish; and a connecting element for securing the capsule to the prey fish.

### BRIEF DESCRIPTION OF THE DRAWINGS

FIG. 1 shows a bait fish which is to be consumed by a predator/game fish, with the capsule portion of the present invention shown attached thereto, in various possible positions.

FIGS. 2A and 2B show perspective views of two embodiments of the capsule portion of the present invention, for attachment to a prey/bait fish.

### BEST MODE FOR CARRYING OUT THE INVENTION

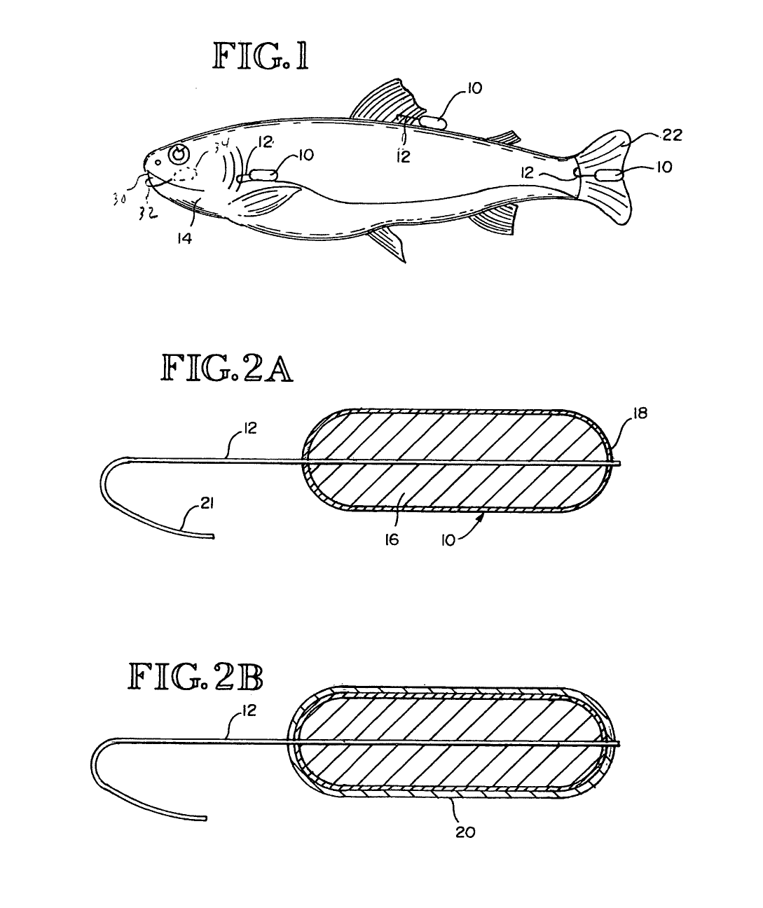

Referring to FIG. 1 in general, the present invention comprises a small capsule 10 which is attached by means of a wire or similar lead element 12 to a prey/bait fish 14, which is a species typically attractive to and hence likely to be consumed by a predator/game fish. The capsuled prey fish are introduced in a given body of water in which there is an imbalance in numbers between the prey fish and the predator fish, favoring the predator fish. The capsule 10 includes a substance 16, typically a poison, which in action operates to kill the predator fish when the predator fish ingests the prey fish. This results in the reduction of the number of predator fish in the body of water.

Referring to FIG. 1, capsule 10 itself in one embodiment is a gelatinous material, similar to ingestible capsules used by humans for various health care purposes (pain treatment, supplements, etc.). In one embodiment, capsule 10 is approximately ½-inch long with a diameter approximately one-third of its length. These dimensions can of course vary. In one embodiment, shown in FIG. 2A, the material comprising the capsule does not dissolve in water but only in the digestive fluids of the predator fish. Alternatively, the capsule could have a wax or other coating 20 (shown in FIG. 2B), which would prevent dissolution of the capsule in water when the capsule comprises a water-soluble material.

In another embodiment, the capsule is made from material which is dissolvable in the aqueous environment. The dissolving rate depends on the particular material comprising the capsule. The gel material used to form the capsule can be made more or less resistant to solubility of water by the addition of selected non-water based substances, such as vegetable oil. Different ratios of such a gel mix result in the capsule dissolving at different rates, depending upon the mix ratio. The time for dissolution could vary, from a relatively short time, i.e. 24 hours, or even somewhat less, to a longer time, such as 72 hours, or even longer, up to a week, or in some cases, even longer.

In such a case, the capsule will dissolve after the selected period of time in the water, if the prey fish is not consumed by a predator fish. The poison being thus released into the aqueous environment is advantageous in the event that the prey species grows to maturity, since the capsule would no longer be present with the fish, and there would be no poison which would otherwise be dangerous to a human who might catch the fish.

Further, following dissolution of the capsule, there would be no danger caused by the prey fish dying from various causes and then washed onto a shoreline, where it could be consumed, along with the capsule and the poison, by scavengers. The small dose of poison within the capsule which is sufficient to kill the predator species will not pose a danger to the overall aqueous environment, such as a lake, because of the rapid dissipation of the poison in the large aqueous environment. This system is hence more desirable than the present conventional method in which the entire environment is poisoned.

Capsule 10 in one embodiment contains a liquid poison which is injected into the capsule by various means; alternatively, the capsule could be molded around a dry poisonous chemical. In both cases, the amount/potency is sufficient to kill the predator fish ingesting the capsule. Typically, the poison has a very short life, so that other species or animals could consume the carcass of the predator fish without harm. Further, the poison will also typically be very fast-acting, so that the predator fish consuming it will die quickly, before it has the opportunity to consume other prey fish. Example of such chemicals, which would provide such desired results, are sodium hydroxide and hydrochloric acid. Other fast-acting poisons are of course possible.

In another embodiment, the contents of the capsule 10 is a strong sedative, which results in the predator fish becoming unconscious and then drowning. In still other alternatives, the material in capsule 10 could be of a kind which would cause other harm sufficient to kill the predator fish, but without poisonous chemicals. One example would be the use of a sponge-like member within a capsule which, when exposed to the fluids in the stomach of the predator fish, expands sufficiently to block the digestive track of the predator fish, thereby causing the death of the predator fish. In another alternative, the capsule material itself could be poisonous or include a sedative.

Further, the contents of the capsule could include a dye, which alternatively or in addition to killing predator fish, could provide information on the feeding patterns of the predator fish.

The capsule 10, as indicated above, is attached to the prey fish 14 by a connecting element, such as a thin wire 12, as shown in the figures. The capsule 10 could be molded around or impaled on an end 18 of wire 12; the other end 21 of the wire can then be arranged in a hook pattern, for instance, and attached to the tail fin 22 or other fin of the prey fish, as shown in FIG. 1. Typically, the length of the wire connecting element 12 will be approximately three inches long, to facilitate the attachment of the capsule to the prey fish. This length results in the capsule being maintained relatively close to the skin surface of prey fish and be generally unnoticed by the predator fish, although the attached capsule may cause the prey fish to act slightly wounded, because of the weight/drag of the capsule. This is typically attractive, to a predator fish.

An alternative to wire is a dissolvable line, such as animal sinew or intestine, or casing material such as used for sausages, which results in the capsule being released from the prey fish after a selected period of time. This has the advantage of preventing a prey fish which is not consumed by a predator fish but is instead caught by a fisherman exposing the capsule to humans because of the wire line attachment. The dissolvable line also prevents the capsule from continuing to be attached to a dead bait fish, which might otherwise float to the surface and be available (and dangerous) to curious humans on the shoreline of the water.

While the prey/bait fish in the embodiment shown is attached to a fin 22 of the prey fish, it should be understood that the capsule could be attached to other portions of the prey fish as well. The capsule could also be secured by an adhesive, or other means, or could be placed under the skin of the prey fish. As indicated above, the capsule will typically have an effect on the movement of the prey fish and thus make the prey fish more attractive to the predator fish. The capsule can be colored to resemble the bait fish or, alternatively, be brightly colored to attract predator fish.

The capsule could, in addition to that disclosed above, be attached inside the mouth of the prey species. In one arrangement, the boney lip area 30 of the prey fish is pierced by a connecting element 32, much as when a fish is caught by conventional means such as by a fishhook. In such an arrangement, the capsule 34 would be carried inside the mouth of the prey fish, in front of the gill system, which would enhance the natural look of the prey fish and make it more enticing to the predator species. The capsule 34 in this arrangement would have the same characteristics as in the other attachment positions, as well as the connecting element. The same dosage of poison would be delivered to the predator fish, with this capsule arrangement, but with less physical damage to the prey species, than when the capsule is attached to the exterior of the fish.

In use, the bait fish with the attached capsule can be introduced to a predator fish by a conventional fish locator to first determine the location, depth and size of the predator fish, and then lowering the bait fish with the attached capsule to a location in a net enclosure, which has a release gate, controlled at the surface. The prey fish will swim out of the enclosure, to be consumed by the predator fish, which will then shortly die, as discussed above.

As indicated above, if a poison is used, the predator fish will be quickly killed by the poison; the predator fish is then either consumed by another species or animal, or simply dissolves in the water. Use of a sedative will result in the drowning of predator fish. The placement of a sufficient number of prey fish with an attached capsule in a selected aqueous environment will result in a significant reduction of the number of predator fish, with a goal of reaching a desired balance between the predator fish and the prey fish in that environment.

In a variation of the above-described embodiment, a capsule similar to capsule 10, with the various alternative arrangements described above, can be attached to a live bait species other than a fish, such as a live mouse or rat, which can be attractive to carnivorous game (fish) species, such as muskie or pike. Such selected fish species often attack live surface-swimming bait. The live bait species could be other live animals as well, such as small rodents, or even birds, ducks and other waterfowl, etc., which could be used to assist in the removal from a given body of water any selected water-borne predator, up to and including snakes and/or alligators and crocodiles. The bait species further could include underwater swimming baits, such as frogs or worms, preferred by certain selected other undesirable species. The bait species can thus be more specifically associated with the control of specific undesirable predator animals and/or fish in a body of water, referred to generally as a predator species.

The above variations permit the management and balance of various species in a body of water, as opposed to just the removal of certain predator fish.

It should be understood that capsule 10 can be connected in various ways to the bait species, such as by the various means described above with respect to the bait fish, as well as any other connecting device.

Similar to that above for a bait fish, the bait species in use is introduced into the body of water near the predator species, using a release trap or similar item in which the water in the release trap may be scented with attractant, such as shrimp oil, or other scent, including various fish oil scents or other fish parts or refuse, i.e. churn, which are attractive to the predator species. Upon release, the bait species will simply swim away naturally and the predator species will ingest the bait species, resulting in death of the predator species, as determined by the material in the capsule, whether it be poison, a sedative, a material which interferes with the digestive process of the predator, or some other lethal means.

In addition, the prey species can be injured or hurt in some way prior to its release into the aqueous environment to give it a “wounded” appearance, which would make a predator fish more likely to attack it.

Although a preferred embodiment of the invention has been disclosed here for purposes of illustration, it should be understood that various changes, modifications and substitutions might be incorporated in the invention without departing from the spirit of the invention, which is defined by the claims which follow.

What is claimed is:

1. A system for controlling the number of a selected population of fish in a given aqueous environment, comprising:
a capsule member which includes material which, following ingestion by a fish in a selected population, results in death of said selected population fish, wherein the capsule is made from a material which dissolves in the digestive fluids of said fish and also dissolves in the aqueous environment at a selected rate, wherein the capsule is secured to a prey fish which is released into the aqueous environment for ingestion by said selected population fish; and
a connecting element for securing the capsule to the prey fish.

2. The system of claim 1, wherein the material resulting in death is a poison, which does not adversely affect the aqueous environment if the capsule dissolves therein.

3. The system of claim 1, wherein the selected rate of capsule dissolution in the aqueous environment varies with the composition of the capsule.

4. The system of claim 1, wherein the capsule is secured to the mouth of the prey fish such that the capsule is carried inside the mouth of the fish.

5. The system of claim 1, wherein the prey species is treated prior to release thereof into the aqueous environment to give it an appearance of being injured.

6. The system of claim 6, wherein the prey fish is released into the aqueous environment from a release assembly, which contains scented fish oils and/or churn, which assist in producing a strike on the prey fish by the selected population fish.

7. A system for controlling the number of a selected population fish in a given aqueous environment, comprising:
a capsule member which includes material which, following ingestion by a fish in a selected population results in death of said population fish, wherein the capsule is made from material which dissolves in the digestive fluids of said fish, wherein the capsule is secured to the mouth of a prey fish in such a manner that the capsule is carried inside the mouth of the fish, the prey fish being released into the aqueous for ingestion by said selected population fish; and
a connecting element for securing the capsule to the prey fish.

8. The system of claim 7, wherein the capsule is secured to a boney lip area of the fish.

9. The system of claim 7, wherein the prey fish is released into the aqueous environment from a release assembly, which contains scented fish oils and/or churn which assist in producing a strike on the prey fish by the selected population fish.
